(19) United States
(12) Patent Application Publication
(10) Pub. No.: US 2008/0296349 A1
(43) Pub. Date: Dec. 4, 2008

(54) Method for treating metal member

(76) Inventors: Chiu Tsung Chen, Taichung Hsien (TW); Chia Lin Chou, Taichung Hsien (TW); Chia Lin Li, Taichung Hsien (TW)

Correspondence Address: CHARLES E. BAXLEY, ESQUIRE, 90 JOHN STREET, SUITE 309, NEW YORK, NY, 10038, US

(21) Appl. No.: 11/807,989

(22) Filed: May 30, 2007

(51) Int. Cl. B23K 1/06

(52) U.S. Cl. 228/110.1; 228/1.1

(57) ABSTRACT

A metal member is treated and vibrated with a number of vibrating particles to have the particles to strike and act onto an outer peripheral portion of the metal member in order to smooth the outer peripheral portion of the metal member, the particles are immersed with an additive for allowing the additive to be transmitted from the particles to the metal member and for allowing the outer peripheral portion of the metal member to be polished with the particles, the metal member may have dirt or impurities removed with a sand blasting method. The metal member may be tempered to form an oxidized membrane on the outer peripheral portion of the metal member, and may be immersed with in a rust preventive.

### BACKGROUND OF THE INVENTION

1. Field of the Invention

The present invention relates to a method for working or treating or machining or surfacing a metal based member, and more particularly to a method for working or treating or machining or surfacing an outer surface of a metal based member.

2. Description of the Prior Art

Typical metal members or objects or products include an outer peripheral surface required to be treated or machined into a shiny appearance before the metal members or objects or products may be marketed.

For example, the metal members or objects or products are normally treated or machined with electroplating processes, dying processes, grinding processes, polishing processes, etc.

However, the outer surface of the metal based member may also feel coarse after the electroplating processes and/or the grinding processes.

The present invention has arisen to mitigate and/or obviate the afore-described disadvantages of the conventional methods for working or treating or machining or surfacing the metal members or objects.

### SUMMARY OF THE INVENTION

The primary objective of the present invention is to provide a method for suitably working or treating or machining the outer surface of the metal based member and for allowing the outer surface of the metal based member to have a smooth and shiny outer appearance.

In accordance with one aspect of the invention, there is provided a method for treating a metal member comprising preparing the metal member, vibrating a number of vibrating particles to have the particles to strike and act onto an outer peripheral portion of the metal member in order to smooth the outer peripheral portion of the metal member, the particles being immersed with an additive for allowing the additive to be transmitted from the particles to the metal member and for allowing the outer peripheral portion of the metal member to be polished with the particles, removing dirt from the outer peripheral portion of the metal member, tempering the metal member to form an oxidized membrane on the outer peripheral portion of the metal member, removing impurities from the outer peripheral portion of the metal member, and immersing the metal member in a rust preventive for applying the rust preventive onto the outer peripheral portion of the metal member and for forming the final product. The additive may be introduced into the particles, and may then be transmitted from the particles to the metal member for allowing the outer peripheral portion of the metal member to be suitably smoothed or polished with the vibrating particles such that the metal member may include a suitably smoothed and shined or polished outer peripheral portion that may be comfortably grasped or held by the users.

The particles preferably include a cylindrical shape, and are preferably made of porcelain materials.

The dirt removing process is preferably treated with a sand blasting method. The impurities removing process may also preferably be treated with a sand blasting method.

A heat treating process may further be provided for treating the metal member before vibrating the particles and/or after preparing the metal member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating the operating processes of a method in accordance with the present invention.

### DETAILED DESCRIPTION OF THE PREFERRED EMBODIMENT

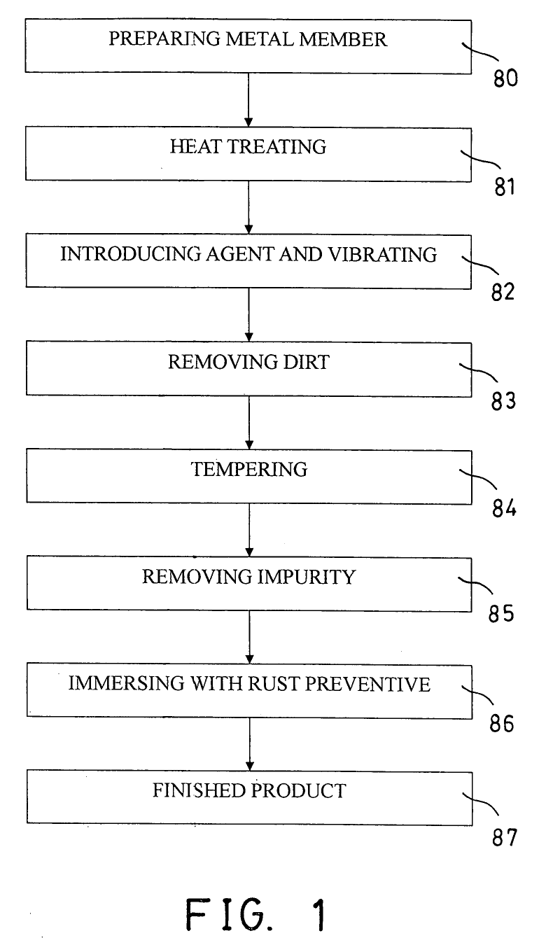

Referring to FIG. 1, a method in accordance with the present invention is provided for working or treating or machining or surfacing an outer surface of a metal based member and comprises preparing a metal based member or object in a first process 80, the metal member or object is then subjected with a heat treating process 81, in which the metal member or object is subjected with heating, quench hardening, quench tempering, etc. for changing the inner composition or construction of the metal member or object without changing the outer appearance or outer structure of the metal member or object, and/or for changing the inner composition or construction at the outer peripheral surface or portion of the metal member or object.

The metal member or object is then treated with a vibrating process 82 with a number of grinding or cutting stones or vibrating particles, or the vibrating particles and/or the metal member or object are vibrated to have the particles to strike or hammer or act onto the outer peripheral surface or portion of the metal member or object in order to smooth the outer peripheral surface or portion of the metal member or object. The vibrating particles preferably include a small and cylindrical shape and made of porcelain or china materials, and are immersed with various additives or agents, such as softener agent or the like, for allowing the additives or agents to be transferred or transmitted from the particles to the metal member or object, and thus for allowing the outer peripheral surface or portion of the metal member or object to be suitably smoothed and shined or polished with the particles.

The metal member or object is then treated with a cleaning process 83 with such as a shot or sand blasting method in order to remove the dirt or contaminant from the outer peripheral surface or portion of the metal member or object, and is then treated with a tempering process 84 for forming an oxidized membrane on the outer peripheral surface or portion of the metal member or object, in which the oxidized membrane may include a tempering color and may be used for protecting the metal member or object and for anti-rust purposes or for preventing the metal member or object from being rusted.

The metal member or object is then treated with an impurity removing process 85 with such as a shot or sand blasting method in order to remove the impurities or particles from the outer peripheral surface or portion of the metal member or object, and is then treated with an immersing process 86 in a rust preventive, such as a rust preventing oil or rust proofing agent or rust remover, etc., for applying the rust preventive onto the outer peripheral surface or portion of the metal member or object and in order to lubricate the outer peripheral surface or portion of the metal member or object, and to protect the metal member or object and to prevent the outer peripheral surface or portion of the metal member or object from being rusted, and in order to form or to manufacture or to complete the final product in the process 87.

It is to be noted that in the process 82, the additives or agents may be added or introduced into the vibrating particles, and may then be transferred or transmitted from the vibrating particles to the metal member or object for allowing the outer peripheral surface or portion of the metal member or object to be suitably smoothed and shined or polished with the vibrating particles such that the metal member or object may include a suitably smoothed and shined or polished outer peripheral surface or portion that may be comfortably grasped or held by the users.

Accordingly, the method in accordance with the present invention may be provided for suitably working or treating or machining the outer surface of the metal based member and for allowing the outer surface of the metal based member to have a smooth and shiny outer appearance.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for treating a metal member comprising:
preparing the metal member,
vibrating a plurality of vibrating particles to have the particles to strike and act onto an outer peripheral portion of the metal member in order to smooth the outer peripheral portion of the metal member, the particles being immersed with an additive for allowing the additive to be transmitted from the particles to the metal member and for allowing the outer peripheral portion of the metal member to be polished with the particles,
removing dirt from the outer peripheral portion of the metal member,
tempering the metal member to form an oxidized membrane on the outer peripheral portion of the metal member,
removing impurities from the outer peripheral portion of the metal member, and
immersing the metal member in a rust preventive for applying the rust preventive onto the outer peripheral portion of the metal member and for forming the final product.

2. The method as claimed in claim 1, wherein the particles include a cylindrical shape.

3. The method as claimed in claim 1, wherein the particles are made of porcelain materials.

4. The method as claimed in claim 1, wherein the dirt removing process is treated with a sand blasting method.

5. The method as claimed in claim 1, wherein the impurities removing process is treated with a sand blasting method.

6. The method as claimed in claim 1 further comprising heat treating the metal member before vibrating the particles.
